(19) United States
(12) Patent Application Publication
(10) Pub. No.: US 2009/0273703 A1
(43) Pub. Date: Nov. 5, 2009

(54) AUTO-FOCUSING DEVICE

(75) Inventor: Yoshikazu Kawauchi, Kanagawa (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 11/813,488

(22) PCT Filed: Jan. 12, 2006
(86) PCT No.: PCT/JP2006/300285

§ 371 Date: Jul. 6, 2007

(30) Foreign Application Priority Data
Jan. 12, 2005 (JP) 2005-005152

(51) Int. Cl. H04N 5/232

(52) U.S. Cl. 348/347; 348/E05.045

(57) ABSTRACT

It is intended to provide an auto-focusing device capable of attaining focus on a subject in a short time even in the case where the lens is defocused to a large extent during zooming. There are provided a camera lens having a zoom lens and a focus lens; an image input portion for taking an optical image of a subject through the camera lens and outputting an image signal; an evaluation value calculating portion for calculating an evaluation value on the basis of high-frequency components of the image signal; and a control portion for executing, during zooming of the zoom lens, a first process (step S204) in which a focusing position of the subject is searched for while the focus lens is vibrated in a front-rear direction of the subject, and for stopping the first process and executing a second process (step S206) in which a focusing position of the subject is searched for by moving the position of the focus lens in an entire movable range if judging, during the first process, that the evaluation value has been smaller than or equal to a first prescribed level for a first prescribed time.

### TECHNICAL FIELD

The present invention relates to an auto-focusing device used in a monitoring camera or the like. In particular, the invention relates to an auto-focusing device which is suitable to always take a well-focused subject image.

### BACKGROUND ART

Monitoring camera systems etc. are equipped with a mechanism for panning and tilting the camera lens is provided to allow the camera lens direction to follow a movement of a subject as well as a zoom mechanism for taking a close-up subject image.

Being an inner focus lens, for example, a focus lens used in a camera lens allows the zoom magnification to be varied while attaining focus. In this case, the focus lens is moved along tracking curves that are specific to the lens. The tracking curves specific to the lens are two tracking curves, that is, one for near-field focusing and one for far-field focusing.

The two tracking curves are almost identical in the case where the zoom magnification is not large. However, as the zoom lens is moved closer to the telephoto side, the two curves are separated more from each other. The focus lens position for attaining focus is at an arbitrary position between the two curves. That is, it becomes more difficult to find a focusing position for a subject as the zoom lens is moved closer to the telephoto side.

In view of the above, for example, the related art disclosed in the following Patent document 1 employs a wobbling AF function of searching for a focusing position by vibrating the focus lens position back and forth in a prescribed range in the subject direction when the lens is rendered out of focus during zooming. This function makes it possible to always take an image with the lens focused on a subject with high accuracy.

Patent document 1: JP-A-2003-51980 (FIG. 4)

### DISCLOSURE OF THE INVENTION

### Problems to be Solved by the Invention

However, the related auto-focusing devices have a problem that if the lens is defocused to a large extent during zooming, focus cannot be attained only by wobbling AF and considerable time is taken until a focused subject image is taken.

An object of the present invention is to provide an auto-focusing device capable of attaining focus on a subject in a short time even in the case where the lens is defocused to a large extent during zooming.

### Means for Solving the Problems

The invention provides an auto-focusing device comprising a camera lens that has a zoom lens and a focus lens; an image input portion that takes an optical image of a subject through the camera lens and outputs an image signal; an evaluation value calculating portion that calculates an evaluation value on the basis of high-frequency components of the image signal; and a control portion that executes, during zooming of the zoom lens, a first process in which a focusing position of the subject is searched while the focus lens is vibrated (wobbled) in a front-rear direction of the subject, and stops the first process and executes a second process in which a focusing position of the subject is searched by moving the position of the focus lens in an entire movable range if it is judged, during the first process, that the evaluation value is smaller than or equal to a first prescribed level for a first prescribed time.

This configuration makes it possible to reach a focusing position reliably in a short time even in the case where the lens is defocused to a large extent during zooming.

The control portion of the auto-focusing device according to the invention executes the second process after the position of the zoom lens reaches a telephoto-side end.

According to this configuration, a zoom operation is continued even if the lens is defocused to a large extent during zooming. A focusing position can be reached reliably after the zoom lens position reaches the telephoto-side end.

The control portion of the auto-focusing device according to the invention judges whether or not the evaluation value is larger than or equal to a second prescribed level for a second prescribed time if it is judged that the evaluation value is not smaller than or equal to the first prescribed level for the first prescribed time, and executes the first process if it is judged that the evaluation value is larger than or equal to the second prescribed level for the second prescribed time.

This configuration prevents a judgment error and thereby makes it possible to search for a focusing position reliably by the second process in the case where focus has not been attained yet.

In the auto-focusing device according to the invention, the first prescribed time and the second prescribed time are different from each other.

This configuration makes it possible to select an optimum value from a wide selection range using various combinations of the first prescribed time and the second prescribed time.

In the auto-focusing device according to the invention, the first prescribed time and the second prescribed time are the same.

Employing the same judgment criterion, this configuration can prevent occurrence of an undesirable judgment error.

In the auto-focusing device according to the invention, a threshold value which is used for judgment of the evaluation value is a function of luminance of the image signal.

This configuration makes it possible to reduce the influence of a luminance variation because the threshold value for the judgment of the evaluation value varies according to a luminance variation of an image signal.

The control portion of the auto-focusing device according to the invention decreases width of the vibration before executing the first process.

This configuration prevents a phenomenon that the vibration width of the first process is so great that the lens position goes further past a focusing position in the case where the focusing position is close. As a result, focus can be attained smoothly without causing a hunching phenomenon that the lens position is moved back and forth around the focusing position.

In the control portion of the auto-focusing device according to the invention, if it is judged that the evaluation value is smaller than or equal to the first prescribed level for the first prescribed time, the control portion executes the second process or executes the first process with increased width of the vibration depending on a result of comparison between a current width of the vibration and a threshold value of the width of the vibration.

This configuration makes it possible to find a focusing position reliably by the second process even in the case where a focusing position has not been found by the first process.

The control portion of the auto-focusing device according to the invention decreases a zoom speed of the zoom lens if it is judged that the evaluation value is smaller than or equal to the first prescribed level for the first prescribed time,

With this configuration, since the decrease of the zoom speed produces an extra time, even if the lens is defocused to a large extent during zooming, a focusing position can be searched for while various functions are performed until focus is attained.

The control portion of the auto-focusing device according to the invention decreases width of the vibration when decreasing the zoom speed.

Even if the lens is defocused to a large extent during zooming, this configuration makes it possible to reach a focusing position relatively smoothly without causing an uncomfortable feeling in a zoom operation with a low probability of occurrence of a judgment error.

### Advantages of the Invention

The invention can provide an auto-focusing device capable of attaining focus on a subject in a short time even in the case where the lens is defocused to a large extent during zooming.

### BRIEF DESCRIPTION OF THE DRAWINGS

FIG. 1 shows the configuration of a camera system incorporating an auto-focusing device according to a first embodiment of the invention;

FIG. 2 is a flowchart of a processing procedure of the auto-focusing device according to the first embodiment of the invention;

FIG. 3 is a flowchart of a processing procedure of an auto-focusing device according to a second embodiment of the invention; and

FIG. 4 is a flowchart of a processing procedure of an auto-focusing device according to a third embodiment of the invention.

### DESCRIPTION OF SYMBOLS

10: Camera lens system
11: Zoom lens
12: Focus lens
20: Imaging portion (image input portion)
30: Camera control section
33: AFDSP (evaluation value calculating portion)
40: Lens control section (control portion)
47: Lens control instruction section

### BEST MODE FOR CARRYING OUT THE INVENTION

One embodiment of the present invention will be hereinafter described with reference to the drawings.

### Embodiment 1

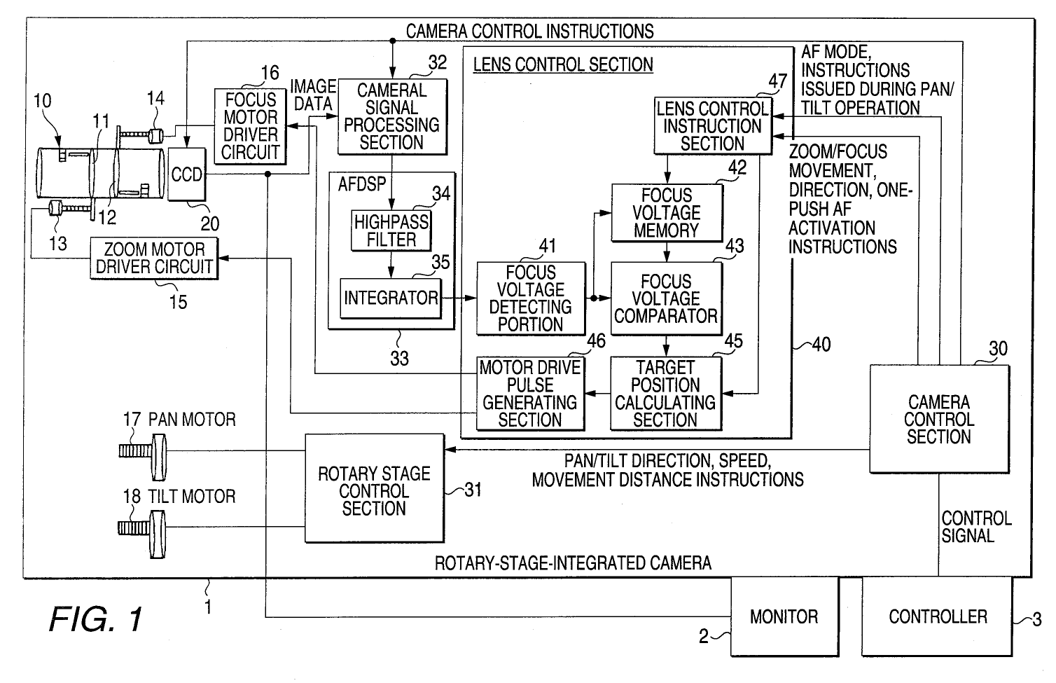

FIG. 1 is a block diagram of a camera incorporating an auto-focusing device according to a first embodiment of the invention. A camera lens system 10 of the camera 1 consists of a zoom lens 11 and a focus lens 12. The position, in the lens barrel, of the zoom lens 11 is moved in the front-rear direction (the direction toward a subject is defined as the forward direction and the direction toward the imaging device is defined as the backward direction) by a zoom motor (stepping motor) 13, and the position, in the lens barrel, of the focus lens 12 is moved in the front-rear direction by a focus motor (stepping motor) 14. The zoom motor 13 is supplied with drive power by a zoom motor driver circuit 15 and the focus motor 14 is supplied with drive power by a focus motor driver circuit 16.

An electric control system of the camera 1 is composed of a camera control section 30 which outputs various control signals in response to a manual manipulation instruction from a controller 3, a rotary stage control section 31 which controls a pan motor 17 and a tilt motor 18 on the basis of instructions from the camera control section 30, a camera signal processing section 32 which takes in an image data signal that is output from an imaging device (an image input portion) 20 and outputs it on the basis of an instruction from the camera control section 30, an AFDSP (auto-focus digital signal processor; an evaluation value calculating portion) 33 which processes an image data signal that is output from the camera signal processing section 32 and outputs a voltage corresponding to the degree of focus positioning, and a lens control section (a control portion) 40 which outputs drive pulse signals to the zoom motor drive circuit 15 and the focus motor driver circuit 16 according to control instructions from the camera control section 30 and an output signal of the AFDSP 33.

The rotary stage control section 31 controls the direction (a rotation angle and a dip or elevation) of the camera lens system 10 by controlling the pan motor 17 and the tilt motor 18 by generating control signals on the basis of a pan direction instruction, a tilt direction instruction, pan and tilt movement speed instructions, and pan and tilt movement distance instructions that are output from the camera control section 30.

An image data signal that is output from the imaging device 20 which is disposed at the focus position of the camera lens system 10 is output to a monitor 2 and used for display of a monitoring image, and is taken in by the AFDSP 33 via the camera signal processing section 32. The AFDSP 33 serves to output an integration value of high-frequency components of an image data signal taken in, and is composed of a highpass filter 34 for extracting high-frequency components of an image data signal and an integrator 35 for integrating the extracted high-frequency components. A sharper image that is higher in the degree of focus is produced as the output value of the integrator 35 is larger, that is, the amount of high-frequency components is larger. Therefore, the voltage corresponding to the output of the integrator 35 is called “focus voltage.”

The lens control section 40 is composed of a focus voltage detecting portion 41 for detecting an output of the integrator 35, a focus voltage memory 42 for storing a focus voltage that is generated before a lens movement, a focus voltage comparator 43 for comparing a current detection value of the focus voltage detecting portion 41 with the value (preceding detection value) stored in the focus voltage memory 42, a target position calculating section 45 for calculating lens movement target positions according to an output of the focus voltage comparator 43, a motor drive pulse generating section 46 which generates pulses for moving the focus lens 12 and the zoom lens 11 by differences between their current positions and movement target positions that are output from the target position calculating section 45 and outputs the generated pulses to the driver circuits 16 and 15, and a lens control instruction section 47 which takes in the storage data of the focus voltage memory 42 or an output signal of the focus voltage detecting portion 41 and performs various kinds of processing (described later).

The reason why the focus voltage comparator 43 compares focus voltages generated before and after a lens movement is to attain focus by moving the focus lens 12 in such a direction that the focus voltage increases only when the current detection value is larger than the preceding one. In this manner, what is called a mountain climbing type focusing position search is performed.

The lens control instruction section 47 receives control instructions from the camera control section 30 and controls the lens control section 40 in a manner described later in detail, and thereby performs auto-focus positioning processing even during a pan operation, a tilt operation, or a zoom operation.

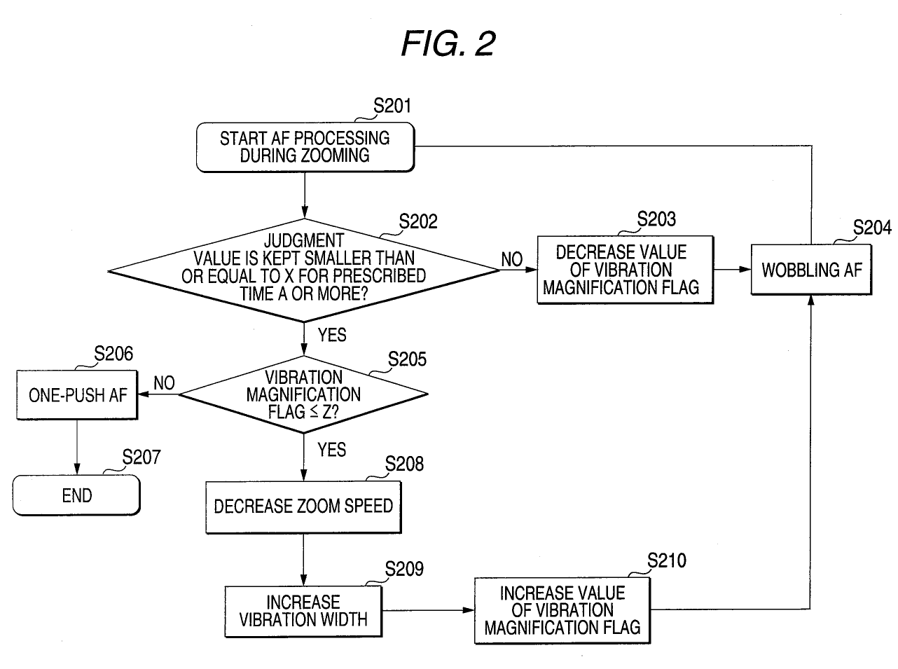

FIG. 2 is a flowchart of a processing procedure which the lens control instruction section 47 follows to control the lens control section 40 in response to control signals from the camera control section 30.

In this embodiment, first, at step S201, AF processing is started during zooming (including panning and tilting). Then, it is judged at step S202 whether or not an integration value (VL value; evaluation value) of high-frequency components of an image taken has been kept smaller than or equal to a prescribed level X for a prescribed time A or more. If it is judged that the VL value has not been kept smaller than or equal to the prescribed level X for the prescribed time A or more, it means that the VL value has increased and a mountain direction (focusing position direction) has been found. Therefore, the value of a vibration magnification flag which determines the vibration magnification of wobbling AF (first process) is decreased at step S203 and the process moves to a wobbling AF process (step S204).

If it is judged at step S202 that the VL value has been kept smaller than or equal to the prescribed level X for the prescribed time A or more, the value of the vibration magnification flag is compared with a default value Z at step S205. If the result of the comparison is that the value of the vibration magnification flag is smaller than or equal to the default value Z, the zoom speed is decreased at step S208, the vibration width of the wobbling AF is increased at step S209, and the value of the vibration magnification flag is increased at step S210. Then, the process moves to the wobbling AF process (step S204).

If it is judged at step S205 that the value of the vibration magnification flag is larger than the default value Z, the process moves to a one-push AF process (step S206) in which focusing is done by performing, only once, an auto-focus function of performing what is called a “mountain search” in which a focusing position is searched for by moving the focus lens 12 in the entire movable range. Focus on the subject is thus attained and the process is finished (step S207).

As described above, according to the embodiment, if the lens is defocused to a large extent during zooming, the one-push AF process is executed rather than the wobbling AF process. This makes it possible to obtain a focused subject image in a short time.

### Embodiment 2

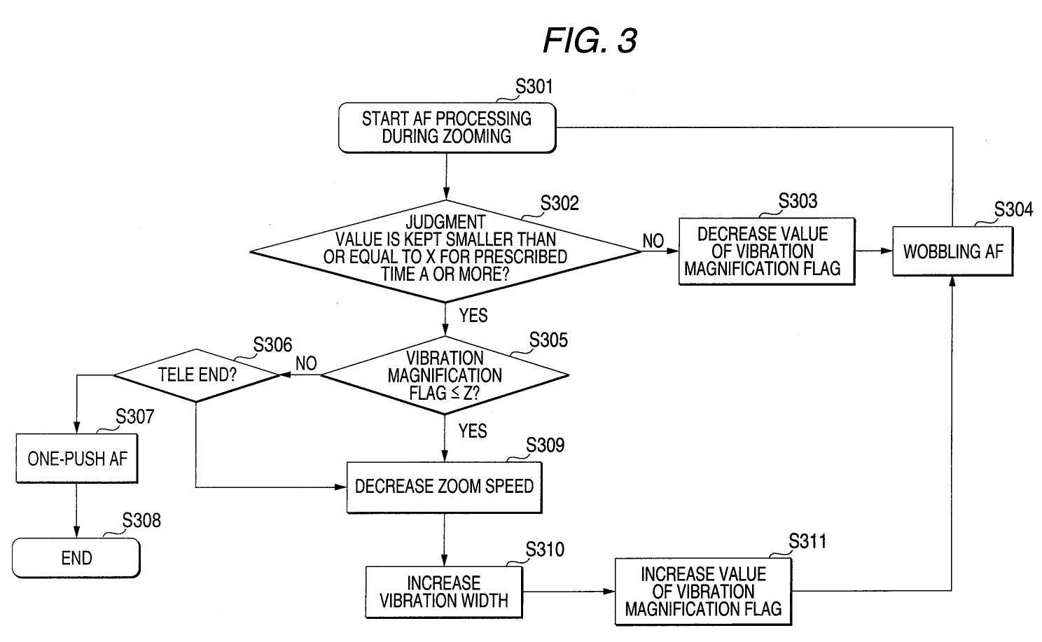

FIG. 3 is a flowchart of a processing procedure which the lens control instruction section 47 according to a second embodiment of the invention follows. The hardware configuration is the same as in the first embodiment (see FIG. 1).

In this embodiment, first, at step S301, AF processing is started during zooming (including panning and tilting). Then, it is judged at step S302 whether or not an integration value (VL value; evaluation value) of high-frequency components of an image taken has been kept smaller than or equal to a prescribed level X for a prescribed time A or more. If it is judged that the VL value has not been kept smaller than or equal to the prescribed level X for the prescribed time A or more, it means that the VL value has increased and a mountain direction has been found. Therefore, the value of a vibration magnification flag is decreased at step S303 and the process moves to a wobbling AF process (step S304).

If it is judged at step S302 that the VL value has been kept smaller than or equal to the prescribed level X for the prescribed time A or more, the value of the vibration magnification flag is compared with a default value Z at step S305. If the result of the comparison is that the value of the vibration magnification flag is smaller than or equal to the default value Z, the zoom speed is decreased at step S309, the vibration width of the wobbling AF is increased at step S310, and the value of the vibration magnification flag is increased at step S311. Then, the process moves to the wobbling AF process (step S304).

If it is judged at step S305 that the value of the vibration magnification flag is larger than the default value Z, it is judged at step S306 whether or not the zoom lens position is the tele (telephoto-side) end. If the zoom lens position has not reached the tele end, the process moves to step S309 to return to the processing loop in which the zoom speed is decreased and wobbling AF processing is performed.

If it is judged at step S306 that the zoom lens position is the tele end, the process moves to a one-push AF process (step S307) in which focusing is done by performing an auto-focus function only once. A focused subject image is taken and the process is finished (step S308).

As described above, according to the embodiment, a zoom operation is continued even if the lens is defocused to a large extent during zooming. Focus can be attained reliably after the zoom lens position reaches the telephoto-side end.

### Embodiment 3

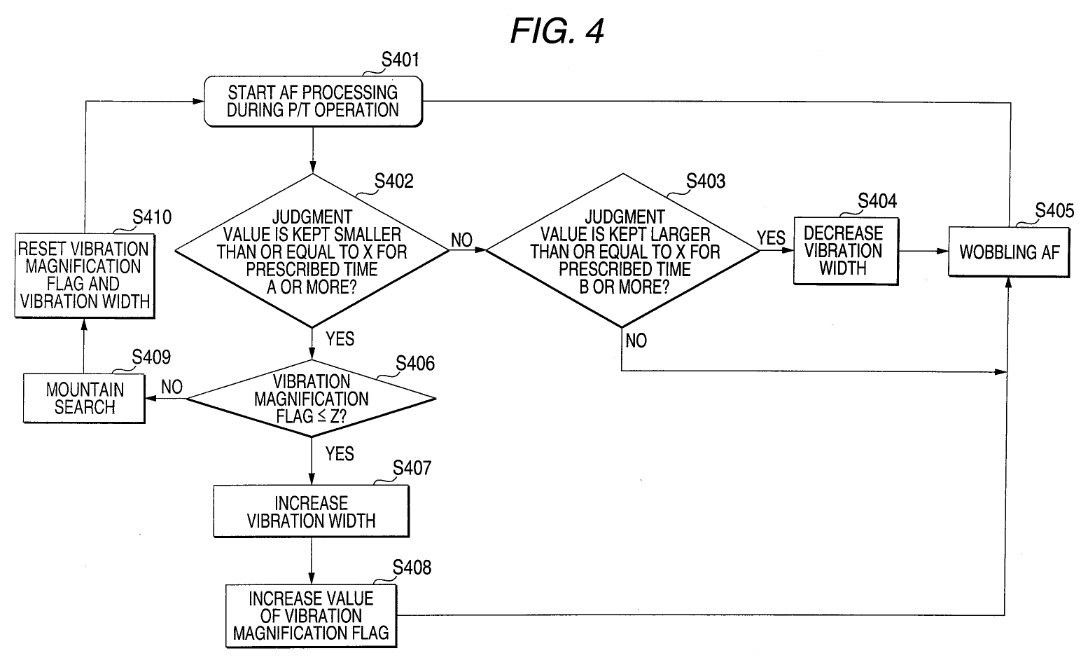

FIG. 4 is a flowchart of a processing procedure which the lens control instruction section 47 according to a third embodiment of the invention follows. The hardware configuration is the same as in the first embodiment (see FIG. 1).

In this embodiment, first, at step S401, AF processing is started during panning and tilting (P/T). Then, it is judged at step S402 whether or not an integration value (VL value; evaluation value) of high-frequency components of an image taken has been kept smaller than or equal to a prescribed level X for a prescribed time A or more.

If it is judged that the VL value has not been kept smaller than or equal to the prescribed level X for the prescribed time A or more, it means that the VL value has increased and a mountain direction has been found. Therefore, it is then judged at step S403 whether or not the VL value has been kept larger than or equal to the prescribed level X for a prescribed time B or more. If it is judged that the VL value has been kept larger than or equal to the prescribed level X for the prescribed time B or more, increase of the VL value is ascertained. At step S404, the vibration width of the focus lens to be employed in wobbling AF processing is decreased to avoid a large deviation from the peak of the mountain. The process then moves to a wobbling AF process (step S405).

If it is judged at step S403 that the VL value has not been kept larger than or equal to the prescribed level X for the prescribed time B or more, the vibration width is kept as it is (i.e., step S404 is skipped) and the process moves to the wobbling AF process (step S405).

If it is judged at step S402 that the VL value has been kept smaller than or equal to the prescribed level X for the prescribed time A or more, the value of the vibration magnification flag is compared with a default value Z at step S406. If the result of the comparison is that the value of the vibration magnification flag is larger than the default value Z, it means that it has been attempted to increase the value of the vibration magnification flag more than a prescribed number of times. Therefore, it is judged that a VL value increasing direction has not been found and a transition is made to a mountain search process, that is, a one-push AF process (step S409). At this time, the value of the vibration magnification flag is returned to “0” and the vibration width is returned to the initial value at step S410. The process returns to step S401.

If it is judged at step S406 that the value of the vibration magnification flag is smaller than or equal to the default value Z, the vibration width of the wobbling AF process is increased at step S408 and the value of the vibration magnification flag is increased at step S408. Then, the process moves to the wobbling AF process (step S405).

As described above, according to the embodiment, it is judged at step S402 whether or not the evaluation value has been smaller than or equal to the prescribed level X for the prescribed time A and it is further judged at step S403 whether or not the evaluation value has been larger than or equal to the prescribed level X for the prescribed time B; that is, double judgment is made. As a result, even if the evaluation value (VL value) is changed by a variation in luminance or in the subject, the correction function works to enable a judgment which is low in the probability of occurrence of a mistake.

Setting different values for the prescribed times A and B enables wide-range combinations of A and B and thereby makes it possible to select values that are most suitable for environment conditions of the camera. More specifically, setting A and B so that a condition A>B is satisfied assures good results in which images are produced stably in short focusing times.

It is preferable to set the value X of step S402 equal to that of step S403. Setting them at the same value equalizes the judgment criteria of steps S402 and S403, which lowers the frequency of occurrence of a different judgment due to a difference between the judgment criteria.

Furthermore, for the following reason, it is preferable that the prescribed level as the threshold value for the judgment of a calculated evaluation value (VL value) be a function of the luminance DC (average luminance) of an image signal. The absolute value of an evaluation value (VL value) which is obtained by extracting high-frequency components of an image signal is influenced by the magnitude of the luminance. Therefore, it is desirable to set a reference luminance value and calculating an evaluation value through normalization by the reference luminance value.

However, since an image signal produced by the camera is a moving image which varies with time, performing normalization by setting a reference luminance value requires a storage device such as a frame memory. This is not realistic because it increases the device size as well as cost increase. The influence of a luminance variation can be reduced by correlating the prescribed level as the threshold value for the judgment of an evaluation value with the luminance of an image signal.

For example, the prescribed value X may be correlated with the luminance DC in the form of a linear (first-order) equation having coefficients a and b, that is, X=a×DC+b. In this case, the prescribed level X increases as the luminance DC increases and the former decreases as the latter decreases. The probability of occurrence of a judgment error due to a luminance variation can thus be reduced.

This effect is enhanced by setting the coefficients a and b properly. The prescribed value X may be correlated with the logarithm of the luminance DC in the form of a linear (first-order) equation, that is, X=a×ln(DC+1)+b where a and b are coefficients. The reason why the logarithm of the luminance DC plus 1 is taken is to avoid an event that the prescribed level X becomes negative. Taking the logarithm of the luminance DC provides an advantage that the rate of increase of the prescribed level X is lowered when the luminance DC increases.

It is expected that changing, in the above manner, the function that correlates the above two parameters according to an image signal obtained from a subject provides various advantages. Although the two parameters are correlated with each other by the first-order equations in the above examples, they may be correlated with each other by a second-order equation or an even higher order equation.

As described above by using the flowchart of FIG. 4, if the judgment result of step S402 (first judgment step) is that the evaluation value has not been smaller than or equal to the prescribed level for the prescribed time, the process moves to step S403 (second judgment step), where it is judged whether or not the evaluation value has been larger than or equal to the prescribed level for the prescribed time. Even if it is judged at the first judgment step that the evaluation value has not been smaller than or equal to the prescribed level for the prescribed time and hence a mountain direction has been recognized because the evaluation value had a value that is larger than the threshold value, it may be that the luminance of the subject happened to vary to produce a large evaluation value to thereby allow recognition of the mountain direction. In view of this, in this embodiment, the second judgment step is further executed, where it is judged whether or not the evaluation value has been larger than or equal to the prescribed level for the prescribed time. This procedure can minimize the probability of occurrence of a judgment error due to influence of a luminance variation or the like.

If it is judged at the second judgment step that the evaluation value has been larger than or equal to the prescribed level for the prescribed time, the recognition of a mountain direction is highly reliable. Therefore, the vibration width is decreased to avoid going too far past the peak of the mountain in a wobbling operation (step S404). This measure prevents a phenomenon that the vibration width of wobbling AF is so great that the lens position goes too far past a focusing position in the case where the focusing position is close; that is, the above measure prevents a hunching phenomenon that the lens position is moved back and forth around the focusing position. The peak of the mountain can thus be reached reliably and smoothly.

If it is judged at the first judgment step that the evaluation value has been smaller than or equal to the prescribed level for the prescribed time, the current vibration width is compared with the threshold value of the vibration width and the process moves to the mountain search process or the wobbling AF process (after the vibration width is increased). A mountain search is performed as long as a mountain direction is not clarified even if the value of the vibration magnification flag has reached the default value. If the value of the vibration magnification flag has not reached the default value, wobbling AF is performed after the wobbling vibration width and the value of the vibration magnification flag are increased. This procedure makes it possible to attain focus reliably without causing a judgment error.

The invention has been described in detail using the particular embodiments, it is apparent to those skilled in the art that various changes and modifications are possible without departing from the spirit and scope of the invention.

This application is based on Japanese Patent Application No. 2005-005152 filed on Jan. 12, 2005, the disclosure of which is incorporated by reference herein.

### INDUSTRIAL APPLICABILITY

The auto-focusing device according to the invention provides an advantage that focus can be attained by searching for a focusing position quickly even when focus on a subject is lost on the telephoto side of the camera lens. As such, the auto-focusing device according to the invention is useful when used in a monitoring camera system etc.

1. An auto-focusing device comprising:
a camera lens that has a zoom lens and a focus lens;
an image input portion that takes an optical image of a subject through the camera lens and outputs an image signal;
an evaluation value calculating portion that calculates an evaluation value on the basis of high-frequency components of the image signal; and
a control portion that executes, during zooming of the zoom lens, a first process in which a focusing position of the subject is searched while the focus lens is vibrated in a front-rear direction of the subject, and stops the first process and executes a second process in which a focusing position of the subject is searched by moving the position of the focus lens in an entire movable range if it is judged, during the first process, that the evaluation value is smaller than or equal to a first prescribed level for a first prescribed time.

2. The auto-focusing device according to claim 1, wherein the control portion executes the second process after the position of the zoom lens reaches a telephoto-side end.

3. The auto-focusing device according to claim 1, wherein the control portion judges whether or not the evaluation value is larger than or equal to a second prescribed level for a second prescribed time if it is judged that the evaluation value is not smaller than or equal to the first prescribed level for the first prescribed time, and executes the first process if it is judged that the evaluation value is larger than or equal to the second prescribed level for the second prescribed time.

4. The auto-focusing device according to claim 3, wherein the first prescribed time and the second prescribed time are different from each other.

5. The auto-focusing device according to claim 3, wherein the first prescribed time and the second prescribed time are the same.

6. The auto-focusing device according to claim 1, wherein a threshold value which is used for judgment of the evaluation value is a function of luminance of the image signal.

7. The auto-focusing device according to claim 3, wherein the control portion decreases width of the vibration before executing the first process.

8. The auto-focusing device according to claim 1, wherein if it is judged that the evaluation value is smaller than or equal to the first prescribed level for the first prescribed time, the control portion executes the second process or executes the first process with increased width of the vibration depending on a result of comparison between a current width of the vibration and a threshold value of the width of the vibration.

9. The auto-focusing device according to claim 1, wherein if it is judged that the evaluation value is smaller than or equal to the first prescribed level for the first prescribed time, the control portion decreases a zoom speed of the zoom lens.

10. The auto-focusing device according to claim 9, wherein the control portion increases width of the vibration when decreasing the zoom speed.
